(19) United States
(12) Patent Application Publication
(10) Pub. No.: US 2013/0106370 A1
(43) Pub. Date: May 2, 2013

(54) METHOD AND DEVICE FOR CONTROLLING SOFT START OF A POWER SUPPLY

(71) Applicants: Yu-Tzung Lin, New Taipei City (TW); Chun-Kai Yeh, New Taipei City (TW)

(72) Inventors: Yu-Tzung Lin, New Taipei City (TW); Chun-Kai Yeh, New Taipei City (TW)

(73) Assignee: ACBEL POLYTECH INC., New Taipei City (TW)

(21) Appl. No.: 13/572,950

(22) Filed: Aug. 13, 2012

(30) Foreign Application Priority Data
Oct. 26, 2011 (TW) 100138772

(51) Int. Cl. G05F 1/10

(52) U.S. Cl. 323/234

(57) ABSTRACT

A method for controlling soft start of a power supply performs soft start under an open loop control mode after the power supply is started, enters a switching control mode when output voltage of the power supply reaches a reference value, starts to convert the output voltage of the power supply into digital data using an analog-to-digital converter for determining if the power supply is switched to a closed loop control mode and the output voltage is adjusted under the switching control mode. Using the foregoing technique can enhance the bit length utilization rate of the analog-to-digital converter, ensure a smooth waveform of the output voltage and suppress maximum excess or minimum deficiency or a transient response at the switching control mode.

### BACKGROUND OF THE INVENTION

1. Field of the Invention

The present invention relates to a power supply and more particularly to a method and device for controlling soft start of the power supply.

2. Description of the Related Art

The so-called soft start means a process of a power supply outputting voltage (V_{O}) from zero to a stable reference value (V_{O,ref}) after starting. With reference to FIG. 6, an ideal output voltage curve is shown. Normal soft start can be classified as open loop control and closed loop control.

With reference to FIG. 7, a conventional switching power supply system has a switching power supply 70, an analog-to-digital converter 71, a digital compensator 72 and a digital pulse width modulator (DPWM) 73.

The switching power supply 70 converts DC input power and then transmits the input power to a load, and output voltage is fed back to the switching power supply 70 through the analog-to-digital converter 71, the digital compensator 72 and the DPWM 73 to control the switching power supply 70 and regulate the output voltage of the switching power supply 70.

The analog-to-digital converter 71 converts the output voltage of the switching power supply 70 to a digital voltage value. The digital voltage value is compensated by the digital compensator 72, and then the compensated digital voltage value is sent to DPWM 73. The DPWM 73 outputs command signal to the switching power supply 70 according to the compensated digital voltage value. The switching power supply 70 regulates the output voltage within a preset range according to the command signal.

Based on foregoing description, the analog-to-digital converter 71 in the conventional switching power supply system roughly has eight-bit data processing capacity for converting output voltage into digital data and outputting the digital data to the digital compensator 72 at a high speed pulse frequency to serve as a reference. Hence, the precision of the output voltage depends on the bit length of the analog-to-digital converter 71.

When the foregoing switching power supply system performs soft start at a open loop control mode and stable operation at a closed loop control mode, the analog-to-digital converter 71 is only operated during the stable operation and a range of the output voltage (V_{O}) is controlled around the stable reference value (V_{O,ref}) so that utilization rate of the bit length of the analog-to-digital converter 71 is increased. When the switching power supply system is activated to reach the stable reference value (V_{O,ref}) and switches from the open loop control mode to the closed loop control mode, with reference to FIGS. 8A and 8B, the output voltage having a maximum excess or a minimum deficiency above or below the stable reference value occurs upon the switching. If the output voltage is too high, the switching power supply system enters an over-voltage protection mode. If the output voltage is too low, the switching power supply system restarts.

If performing the soft start at the closed loop control mode throughout its operation, the switching power supply system has the following advantages:

1. As the operation from the starting to the stable operation pertains to a closed loop control, the waveform of the output voltage during the starting process is smooth and the curve of the output voltage (V_{O}) resembles the ideal curve shown in FIG. 6.

2. Since the entire operation pertains to a closed loop control, the maximum excess or minimum deficiency of the output voltage occurring at the transition moment from the starting to the stable operation can be suppressed as much as possible.

Despite the aforementioned advantages, the closed loop control is not flawless at all. Under the circumstance of the closed loop control throughout the entire operation, the value conversion range of the analog-to-digital converter must cover the starting throughout the operation. Limit cycle arising from insufficient resolution required in the stable operation occurs. To solve the resolution insufficiency, an analog-to-digital converter having higher bit length may be brought into play while such option inevitably increases the cost and power consumption of the switching power supply system.

### SUMMARY OF THE INVENTION

A first objective of the present invention is to provide a method for controlling soft start of a power supply to effectively integrate open loop control and closed loop control, significantly improving the bit length utilization rate of an analog-to-digital converter, ensuring a smooth waveform of the output voltage of the power supply, and suppressing maximum excess or minimum deficiency occurring from starting to stable operation of the power supply to enhance the starting stability of the power supply.

To achieve the foregoing objective, the method for controlling soft start of a power supply, wherein the power supply is connected to a digital pulse width modulator (DPWM) and has a voltage output terminal connected to a load and a stable operation voltage value, and the DPWM modulates a pulse width of an output voltage of the power supply to control the output voltage within a preset voltage range, is performed by a device having an analog-to-digital converter and a digital compensator, connected between the voltage output terminal of the power supply and the DPWM, and performing the following steps after the power supply is started controlling soft start of the power supply and has the following steps:

entering an open loop control mode and progressively increasing the output voltage of the power supply from zero;

determining if the output voltage reaches a reference voltage value; and

when the output voltage reaches the reference voltage value, entering a switching control mode for the analog-to-digital converter to convert the output voltage into digital data for determining to switch to a closed loop control mode and adjusting the output voltage.

In the foregoing method, both open loop control and closed loop control are sequentially applied during the starting process of the power supply. During the open loop control mode, the analog-to-digital converter is not applied to control the output voltage of the power supply in the beginning and does not start to convert the output voltage into digital data until the output voltage is greater than the reference voltage value. The power supply then enters the closed loop control mode and the output voltage thereof is controlled under the closed loop control mode. After the power supply enters a stable state, the close loop control is still in progress and the analog-to-digital converter continuously converts the output voltage into digital data and provides the digital data to the digital compensator for the digital compensator to change the pulse width of the signal outputted from the DPWM so as to control the output voltage of the power supply within a voltage range. Using the foregoing method has the following advantages.

1. Smooth waveform of output voltage: After being started, the power supply enters the open loop control mode. The power supply is switched to the closed loop control mode before entering a stable state. Under the closed loop control mode, a maximum excess or minimum deficiency occurring upon entering from the starting stage to the stable operation can be effectively suppressed to ensure a smooth waveform of the output voltage.

2. Enhanced bit length utilization rate of the analog-to-digital converter: As mentioned earlier, the analog-to-digital converter is not used throughout the entire starting process. In comparison with the full closed loop control, the actual operation time of the analog-to-digital converter is greatly shortened, thereby effectively raising the bit length utilization rate of the analog-to-digital converter.

3. Lower cost and power consumption: As the analog-to-digital converter with longer bit length is not required, overall cost is lowered and unnecessary power consumption can be avoided.

A second objective of the present invention is to provide a device for controlling soft start of a power supply.

To achieve the foregoing objective, with the power supply connected to the digital pulse width modulator (DPWM) for controlling an output voltage of the power supply and having a voltage output terminal and a stable operation voltage value, the device has a switch command generation unit and a loop mode switching unit.

The switch command generation unit is connected between the voltage output terminal and the DPWM and has a level shift and scaling element, an analog-to-digital converter, a voltage discriminator and a state controller. The level shift and scaling element has an input terminal connected to the voltage output terminal of the power supply and an output terminal. The analog to digital converter has an input terminal connected to the output terminal of the level shift and scaling element and an output terminal. The voltage discriminator has a voltage input terminal connected to the output terminal of the analog-to-digital converter, a reference voltage input terminal and an output terminal. The state controller has a first state input terminal, a second state input terminal connected to the output terminal of the voltage discriminator and a switch command output terminal.

The loop mode switching unit is connected between the voltage output terminal and the DPWM and has a first switch, an open loop signal generator, a digital compensator and an initial value generator. The first switch has multiple input terminals, a switch control terminal connected to the switch command output terminal of the state controller and an output terminal connected to the DPWM. The open loop signal generator has an output terminal connected to one of the input terminals of the first switch. The digital compensator has an initial value input terminal, a voltage difference input terminal, an enable terminal connected to the switch command output terminal of the state controller and an output terminal connected to another input terminal of the first switch. The initial value generator has an input terminal connected to the output terminal of the open loop signal generator, a control terminal connected to the switch command output terminal of the state controller and an output terminal connected to the initial value input terminal of the digital compensator.

When the power supply is started, the loop mode switching unit of the device generates a open loop control signal and sends it to the DPWM through the first switch for starting the power supply in the open loop control mode. Meanwhile, the level shift and scaling element of the switch command generation unit performs sampling of the output power of the power supply. When the output voltage is not greater than an unstable operation voltage value, the sampled output voltage to the analog-to-digital converter is zero. Thus, the output of the analog-to-digital converter is also zero. At the moment, the states of outputs of the voltage discriminator and the state controller remain the same. The switch command output terminal of the state controller sends no switch command to the loop mode switching unit to maintain the operation in the open loop control mode. When the output voltage of the power supply is greater than the unstable operation voltage value, the power supply has not entered the state of stable operation, the level shift and scaling element starts outputting the sampled voltage, and the analog-to-digital converter converts the sampled voltage into digital data and sends the digital data to the voltage discriminator to compare with a reference voltage. If the digital data value is greater than the reference voltage, the switch command output terminal of the state controller switches the state and outputs the switching command to the loop mode switching unit.

When the initial value generator of the loop mode switching unit receives the switching command, a corresponding initial value is generated and sent to the digital compensator. After receiving the switching command, the digital compensator starts performing compensation to output a closed loop control signal to the first switch. After the first switch receives the switching command, the open loop control signal is switched off, and a closed loop control signal is sent to the DPWM to perform the closed loop control mode instead.

When the device for controlling soft start of a power supply initially starts the power supply, the open loop control mode is active. When the output voltage reaches an unstable operation voltage, the analog-to-digital converter starts operating to significantly increase the bit length utilization rate of the analog-to-digital converter. Suppose that the stable operation voltage of the power supply is 12V, the unstable voltage value may be set to be 10.5V. As the analog-to-digital converter starts converting the output voltage into data for controlling the output voltage only after the output voltage of the power supply of the present invention is greater than 10.5V, the resolution for controlling the output voltage is greatly enhanced. Besides, similar to the mentioned control method, the control device can ensure the waveform smoothness of the output voltage and avoids the maximum excess or minimum deficiency occurring upon entering the stable operation state.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a system architecture of a device for controlling soft start of a power supply in accordance with the present invention;

FIG. 2 is a functional block diagram of the device for controlling soft start of a power supply in FIG. 1;

FIG. 3 is a waveform diagram illustrating a soft start process in accordance with the present invention;

FIG. 4 is a functional block diagram of a digital compensator of the device in FIG. 2;

FIG. 5 is a functional block diagram of an initial value generator of the device in FIG. 2;

FIG. 6 is a characteristic curve diagram illustrating an ideal soft start of a power supply;

FIG. 7 is a functional block diagram of a conventional switching power supply system; and

FIG. 8A is a characteristic curve diagram of output voltage of a conventional power supply having a maximum excess above a stable reference voltage value during an open/closed loop start mode; and

FIG. 8B is a characteristic curve diagram of output voltage of a conventional power supply having a minimum deficiency below a stable reference voltage value during an open/closed loop start mode.

### DETAILED DESCRIPTION OF THE INVENTION

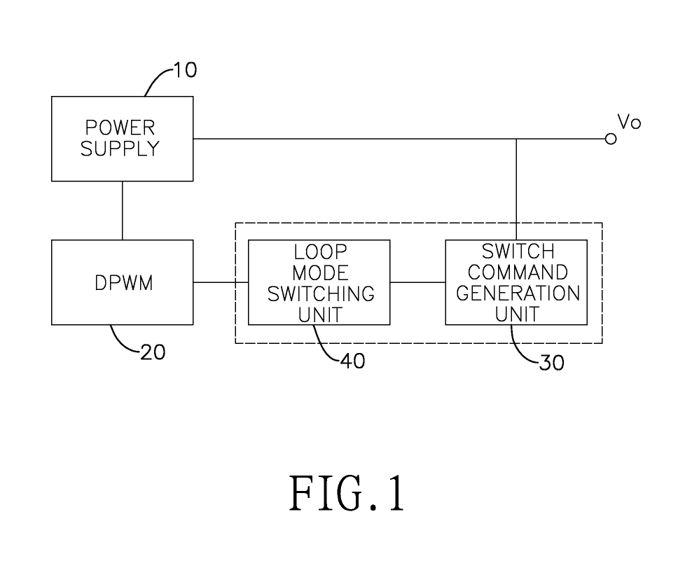

With reference to FIG. 1, the switching power supply system, to which a method and a device for controlling soft start of a power supply in accordance with the present invention is applied, has a power supply 10, a digital pulse width modulator (DPWM) 20, a switch command generation unit 30 and a loop mode switching unit 40. The power supply 10 has a voltage output terminal connected to a load. The DPWM 20 modulates the width of output pulses to control an output voltage V_{O} of the power supply 10 within a preset voltage range. The DPWM 20 has a feedback terminal. The switch command generation unit 30 and the loop mode switching unit 40 are connected between the voltage output terminal and the feedback terminal of the DPWM 20.

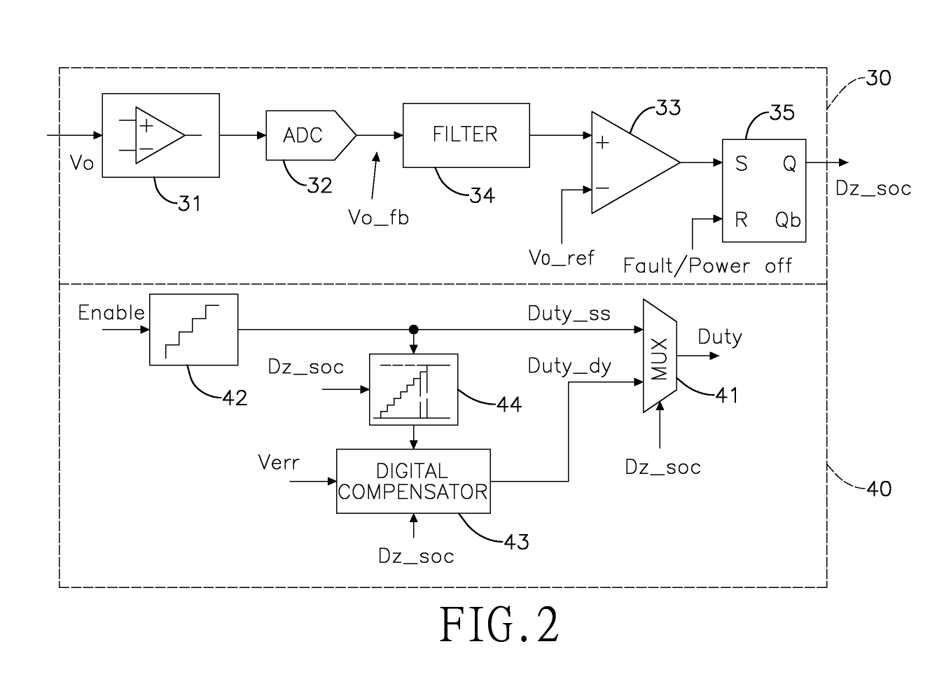

With reference to FIG. 2, the switch command generation unit 30 has a level shift and scaling element 31, an analog-to-digital converter 32, a voltage discriminator 33 and a state controller 35.

The level shift and scaling element 31 has an input terminal and an output terminal. The input terminal is connected to the voltage output terminal of the power supply 10. The level shift and scaling element 31 has an output voltage setting value determined by a stable operation voltage (Vo_ref) of the power supply 10. Suppose that the stable operation voltage of the power supply 10 is 12V, the output voltage setting value can be selected to be an output voltage value, such as 10.5V, of the power supply 10 in a starting process before the power supply 10 enters the stable operation. Before the output voltage of the power supply 10 reaches 10.5V, signals from the output terminal of the level shift and scaling element 31 are always zero.

The analog-to-digital converter 32 has an input terminal and an output terminal. The input terminal of the analog-to-digital converter 32 is connected to the output terminal of the level shift and scaling element 31. As a result of the use of the soft start technique of the present invention, the bit length utilization rate of the analog-to-digital 32 converter including but not limited to an eight-bit analog-to-digital converter is significantly increased. When the output voltage of the level shift and scaling element 31 is zero, the output voltage of the analog-to-digital converter 32 is also zero.

The voltage discriminator 33 has a voltage input terminal, a reference voltage input terminal and an output terminal. The voltage input terminal is connected to the output terminal of the analog-to-digital converter 32. In the present embodiment, the voltage discriminator 33 is composed of a voltage comparator. The voltage input terminal is connected to the output terminal of the analog-to-digital converter 32 through a filter 34. The filter 34 is specifically a finite impulse response (FIR) filter. A reference voltage (Vo_ref) is inputted to the reference voltage input terminal of the voltage discriminator 33.

The state controller 35 is composed of an RS flip flop having a first state input terminal R, a second state input terminal S and a switch command input terminal Q. The second state input terminal S is connected to the output terminal of the voltage discriminator 33. The switch command output terminal Q is connected to the loop mode switching unit 40.

The switch command generation unit 30 generates a switching command Dz_soc to the loop mode switching unit 40 based on variation of the output voltage of the power supply 10 after the power supply 10 is started so as to control the loop mode switching unit 40 to switch the power supply 10 from an open loop control mode to a closed loop control mode during a starting process of the power supply 10.

The loop mode switching unit 40 has a first switch 41, an open loop signal generator 42, a digital compensator 43 and an initial value generator 44.

The first switch 41 has multiple input terminals, a switch control terminal and an output terminal. In the present embodiment, the first switch 41 is composed of a multiplexer, and an output terminal of the multiplexer is connected to the DPWM 20. The switch control terminal is connected to the switch command output terminal Q of the state controller 35.

The open loop signal generator 42 is composed of a counter in the present embodiment, and has an enable terminal and an output terminal. The output terminal of the open loop signal generator 42 is connected to one of the input terminals of the first switch 41. With further reference to FIG. 2, after being started, the power supply 10 enables the open loop signal generator 42 to generate an open loop control signal Duty_ss and sends the open loop control signal to the DPWM 20 through the first switch 41 to perform the open loop control.

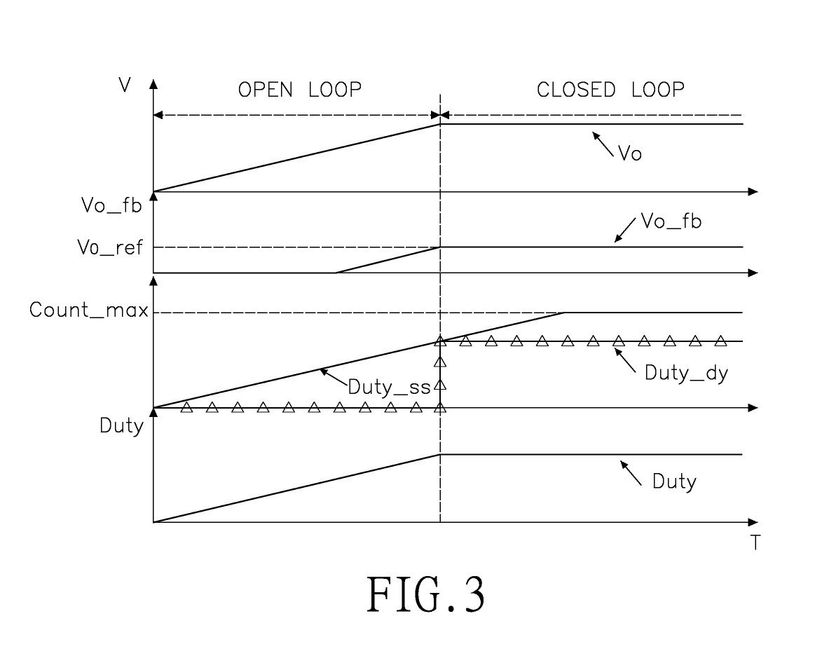

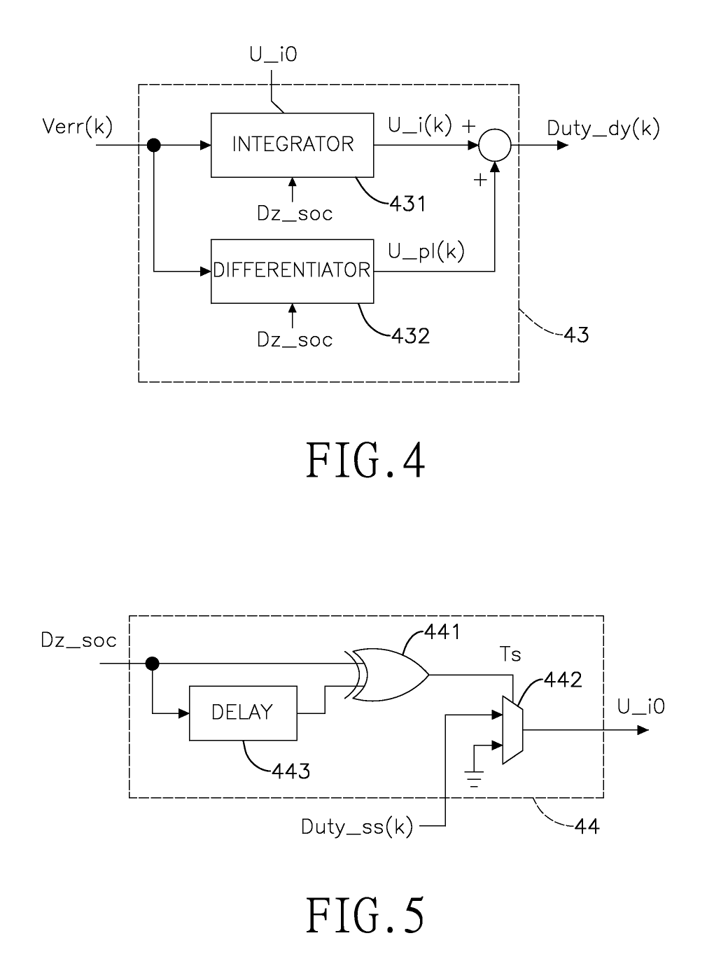

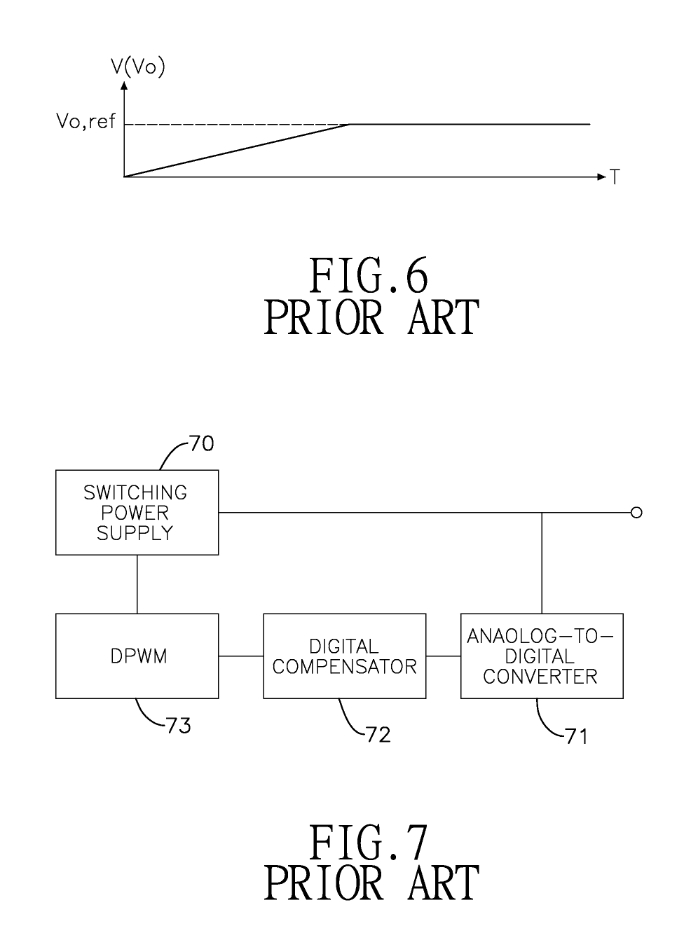

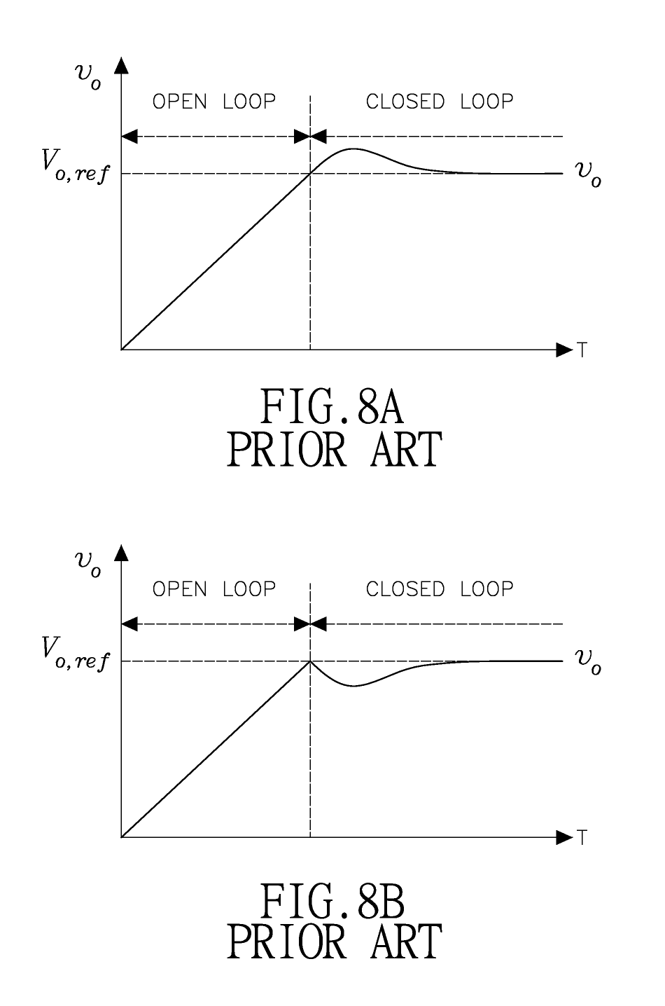

With reference to FIG. 4, the digital compensator 43 is composed of an integrator 431. The integrator 431 has an input terminal, an enable terminal, an output terminal and an initial value input terminal. The input terminal of the integrator 431 serves as an input terminal of a voltage difference Verr. The enable terminal is connected to the switch command output terminal Q to receive the switching command Dz_soc sent from the state controller 35. The output terminal of the integrator 431 sends an output signal U_i(k). After the output signal U_i(k) is computed by an operator, a closed loop control signal Duty_dy is generated as shown in FIG. 3 and is sent to another output terminal of the first switch 41 for the first switch 41 to control if a signal Duty is sent to the DPWM 20. In the present embodiment, the digital compensator 43 further has a differentiator 432. The differentiator 432 has an input terminal, an enable terminal and an output terminal. The input terminal of the differentiator 432 is commonly connected to the input terminal of the integrator 431 and serves as an input terminal of the voltage difference Verr. The enable terminal is enabled by the switching command Dz_soc sent from the switch command generation unit 30. The output terminal of the differentiator 432 outputs an output signal U_pl(k). After the output signal U_pl(k) and the output signal U_i(k) of the integrator 431 are computed by the operator, the closed loop control signal Duty_dy is generated to further increase precision of the closed loop control signal Duty_dy.

The initial value generator 44 has an input terminal, a control terminal and an output terminal. The input terminal of the initial value generator 44 is connected to the output terminal of the open loop signal generator 42. The control terminal is connected to the switch command output terminal Q of the state controller 35 to receive the switching command Dz_soc sent from the state controller 35. The output terminal of the initial value generator 44 is connected to the initial value input terminal of the integrator 431 of the digital compensator 43. With reference to FIG. 5, the initial value generator 44 may be implemented by an XOR (exclusive OR) gate 441 and a second switch 442. The XOR gate 441 has two input terminals and an output terminal. One of the input terminals of the XOR gate 441 is connected to the switch command output terminal Q of the state controller 35. The other input terminal is connected to the switch command output terminal Q through a delay 443 to receive the switching command Dz_soc from the state controller 35. The delay 443 serves to delay the input signal by a timing pulse. The second switch 442 has two input terminals and an output terminal. One of the input terminals of the second switch 442 is connected to the output terminal of the XOR gate 441, and the other input terminal is connected to the output terminal of the open loop signal generator 42.

According to the loop mode switching unit 40, after the power supply 10 turns on, the open loop signal generator 42 outputs an open loop control signal Duty_ss to the DPWM 20 through the first switch 41 to activate the open loop operation. The open-loop control signal Duty_ss is also sent to the second switch 442 of the initial value generator 44. When the second switch 442 receives no signal from the XOR gate 441, the second switch 442 holds the open loop control signal Duty_ss from being sent out.

When the state controller 35 of the switch command generation unit 30 sends out the switching command Dz_soc, the XOR gate 441 outputs a timing signal Ts to the second switch 442. The second switch 442 then treats the output signal of the open loop signal generator 42 as an initial value U_io and sends the initial value to the integrator 431 of the digital compensator 43 for the digital compensator 43 to start compensation according to the voltage difference Verr between the output voltage of the power supply 10 and a target value, generate a closed loop control signal Duty_dy and send the closed loop control signal Duty_dy to the first switch 41 as shown in FIG. 3. Driven by the closed loop control signal Duty_dy and the switching command Dz_soc synchronously, the first switch 41 sends the closed loop control signal Duty_dy to the DPWM 20 to continuously activate with the closed loop control signal Duty_dy instead so that the closed loop control can be constantly carried out after the power supply 10 enters the stable operation.

Whether the digital compensator 43 generates a closed loop control signal Duty_dy and whether the closed loop control signal Duty_dy is outputted from the first switch 41 depends on whether the state controller 35 of the switch command generation unit 30 sends out the switching command Dz_soc. As to how the switch command generation unit 30 generates the switching command Dz_soc, the details are described as follows.

One of the technical characteristics of the present invention lies in enhancement of the utilization rate of the bit length of the analog-to-digital converter. In this regard, when the output voltage Vo of the power supply 10 is less than a preset value, the present invention instructs the analog-to-digital converter 32 to output zero. In other words, before this condition is met, the bits of the analog-to-digital converter are not used at all. After the output voltage Vo is greater than the preset value, the analog-to-digital converter starts to convert the output voltage Vo acquired from the level shift and scaling element 31 into digital data. With further reference to FIG. 3, an output voltage signal Vo_fb is generated after the conversion of the analog-to-digital converter 32 and progressively increases. The output voltage signal Vo_fb passes through the filter 34 and the voltage discriminator 33, and is compared with the reference voltage Vo_ref. When the output voltage signal Vo_fb is greater than the reference voltage Vo_ref, the voltage discriminator 33 then outputs a signal to the state controller 35 and the state controller 35 sends out the switching command Dz_soc so that the loop mode switching unit 40 switches the power supply 10 from the open loop control to the closed loop control and keeps staying in closed loop control after the power supply 10 enters the stable operation. As the analog-to-digital converter 32 starts to operate only after the output voltage Vo of the power supply 10 is greater than a preset value, the bit length utilization rate of the analog-to-digital converter 32 can be effectively raised. For example, suppose that the output voltage of a power supply from the starting to the stable operation is in a range of 0˜12V and the reference voltage of the output voltage is set to be 10.5V. In other words, the analog-to-digital converter 32 only starts to operate after the output voltage Vo of the power supply 10 reaches 10.5V. Since the bit length, such as 8 bits, of the analog-to-digital converter 32 can be fully utilized in the range of the output voltage 10.5V˜12V, the resolution of the analog-to-digital converter can be effectively increased. Additionally, the present invention can switch the power supply 10 to be operated under the closed loop control before the power supply 10 enters the stable operation, thereby ensuring a smooth waveform of the output voltage and effectively suppressing the maximum excess or minimum deficiency occurring upon entering from the starting stage to the stable operation to secure the system stability.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A device for controlling soft start of a power supply, the power supply connected to a digital pulse width modulator (DPWM) for controlling an output voltage of the power supply and having a voltage output terminal and a stable operation voltage value, the device comprising:
a switch command generation unit connected between the voltage output terminal and the DPWM and having:
a level shift and scaling element having:
an input terminal connected to the voltage output terminal of the power supply; and
an output terminal;
an analog to digital converter having:
an input terminal connected to the output terminal of the level shift and scaling element; and
an output terminal;
a voltage discriminator having:
a voltage input terminal connected to the output terminal of the analog-to-digital converter;
a reference voltage input terminal; and
an output terminal;
a state controller having:
a first state input terminal;
a second state input terminal connected to the output terminal of the voltage discriminator; and
a switch command output terminal; and
a loop mode switching unit connected between the voltage output terminal and the DPWM and having:
a first switch having:
multiple input terminals;
a switch control terminal connected to the switch command output terminal of the state controller; and
an output terminal connected to the DPWM;
an open loop signal generator having an output terminal connected to one of the input terminals of the first switch;
a digital compensator having:
an initial value input terminal;
a voltage difference input terminal;
an enable terminal connected to the switch command output terminal of the state controller; and
an output terminal connected to another input terminal of the first switch; and
an initial value generator having:
an input terminal connected to the output terminal of the open loop signal generator;
a control terminal connected to the switch command output terminal of the state controller; and
an output terminal connected to the initial value input terminal of the digital compensator.

2. The device as claimed in claim 1, wherein the digital compensator is composed of an integrator, and the integrator has:
an input terminal serving as an voltage difference input terminal of the digital compensator;
an enable terminal connected to the switch command output terminal of the state controller;
an output terminal connected to the input terminal of the first switch connected to the digital compensator through an operator; and
an initial value input terminal connected to the output terminal of the initial value generator.

3. The device as claimed in claim 2, wherein the digital compensator further has a differentiator, and the differentiator has:
an input terminal and the input terminal of the integrator commonly connected to form the voltage difference input terminal of the digital compensator;
an enable terminal connected to the switch command input terminal of the state controller; and
an output terminal connected to the operator.

4. The device as claimed in claim 3, wherein the initial value generator has:
an exclusive OR (XOR) gate having:
two input terminals, one of the input terminals directly connected to the switch command output terminal of the state controller and the other input terminal connected to the switch command output terminal of the state controller through a delay serving to delay an input signal of the XOR gate by a timing pulse; and
an output terminal; and
a second switch having:
two input terminals, one of the input terminals connected to the output terminal of the XOR gate and the other input terminal connected to the output terminal of the open loop signal generator; and
an input terminal.

5. The device as claimed in claim 4, wherein the open loop signal generator is composed of a counter.

6. The device as claimed in claim 1, wherein the level shift and scaling element has an output voltage setting value being less than the stable operation voltage value.

7. The device as claimed in claim 6, wherein the voltage discriminator is composed of a voltage comparator having a voltage input terminal connected to the output terminal of the analog-to-digital converter through a filter.

8. The device as claimed in claim 7, wherein the filter is composed of a finite impulse response (FIR) filter.

9. The device as claimed in claim 8, wherein the state controller is composed of an RS flip flop having a switch command output terminal connected to the loop mode switching unit.

10. A method for controlling soft start of a power supply, the power supply connected to a digital pulse width modulator (DPWM) and having a voltage output terminal connected to a load and a stable operation voltage value, the DPWM modulating a pulse width of an output voltage of the power supply to control the output voltage within a preset voltage range, a device for controlling soft start of the power supply having an analog-to-digital converter and a digital compensator, connected between the voltage output terminal of the power supply and the DPWM, and performing the following steps after the power supply is started:
entering an open loop control mode and progressively increasing the output voltage of the power supply from zero;
determining if the output voltage reaches a reference voltage value; and
when the output voltage reaches the reference voltage value, entering a switching control mode for the analog-to-digital converter to convert the output voltage into digital data for determining to switch to a closed loop control mode and adjusting the output voltage.

11. The method as claimed in claim 10, wherein the reference voltage value is less than the stable operation voltage value.

12. The method as claimed in claim 11, further comprising in the step of determining if the output voltage reaches a reference voltage value, sampling the output voltage first and then outputting the sampled output voltage to the analog-to-digital converter, before the sampled output voltage reaches the reference voltage value, setting the sampled output voltage to the analog-to-digital converter to be zero, and after the sampled output voltage reaches the reference voltage value, setting the sampled output voltage to be the reference voltage value and enabling the analog-to-digital converter to convert the sampled output voltage into digital data.

13. The method as claimed in claim 10, further comprising:
in the step of entering an open loop control mode, providing an open loop control signal to the DPWM; and
in the step of entering a switching control mode when the output voltage reaches the reference voltage value, enabling the analog-to-digital converter and simultaneously inputting a nonzero initial value thereto for the digital compensator to generate a closed loop control signal according to a voltage difference value and the initial value, sending the closed loop control signal to the DPWM, and simultaneously terminating the open loop control signal.

14. The method as claimed in claim 11, further comprising:
in the step of entering an open loop control mode, providing an open loop control signal to the DPWM; and
in the step of entering a switching control mode when the output voltage reaches the reference voltage value, enabling the analog-to-digital converter and simultaneously inputting a nonzero initial value thereto for the digital compensator to generate a closed loop control signal according to a voltage difference value and the initial value, sending the closed loop control signal to the DPWM, and simultaneously terminating the open loop control signal.

15. The method as claimed in claim 12, further comprising:
in the step of entering an open loop control mode, providing an open loop control signal to the DPWM; and
in the step of entering a switching control mode when the output voltage reaches the reference voltage value, enabling the analog-to-digital converter and simultaneously inputting a nonzero initial value thereto for the digital compensator to generate a closed loop control signal according to a voltage difference value and the initial value, sending the closed loop control signal to the DPWM, and simultaneously terminating the open loop control signal.

16. The method as claimed in claim 13, wherein the open loop control signal is generated by enabling a counter to count after the power supply is started.

17. The method as claimed in claim 14, wherein the open loop control signal is generated by enabling a counter to count after the power supply is started.

18. The method as claimed in claim 15, wherein the open loop control signal is generated by enabling a counter to count after the power supply is started.

19. The method as claimed in claim 16, wherein the initial value inputted to the digital compensator is generated according to a counting value in collaboration with a condition when the output voltage reaches the reference voltage value.

20. The method as claimed in claim 17, wherein the initial value inputted to the digital compensator is generated according to a counting value in collaboration with a condition when the output voltage reaches the reference voltage value.
